(19) United States
(12) Patent Application Publication
(10) Pub. No.: US 2011/0314957 A1
(43) Pub. Date: Dec. 29, 2011

(54) VIBRATION DAMPING DEVICE

(75) Inventors: Thorsten KRAUSE, Buehl (DE); Heiko MAGERKURTH, Freiburg im Breisgau (DE); Parviz MOVLAZADA, Rastatt (DE); Peter DROLL, Karlsruhe (DE)

(73) Assignee: SCHAEFFLER TECHNOLOGIES GMBH & CO. KG, Herzogenaurach (DE)

(21) Appl. No.: 13/171,094

(22) Filed: Jun. 28, 2011

(30) Foreign Application Priority Data
Jun. 29, 2010 (DE) 102010025585.8

(51) Int. Cl. F16F 15/14

(52) U.S. Cl. 74/574.2

(57) ABSTRACT

The invention relates to a vibration damping device in a drive train of a motor vehicle, having an input drive part and an output part that is rotatable to limited extent relative to the input part through the action of at least one energy storage element, there being a pendulum mass carrier situated or formed on the input part and/or the output part, which makes it possible to receive at least one pair of pendulum masses comprising pendulum masses that are situated opposite each other axially on the pendulum mass carrier and are pivotable to a limited extent relative to the latter with the aid of at least one roll-off element, and where the roll-off element, by rolling, passes over a roll-off surface on the pendulum mass carrier and on each of the pendulum masses as the pendulum masses move relative to the pendulum mass carrier, and where the pendulum masses of a pair of pendulum masses have different geometric forms.

### CROSS-REFERENCE TO RELATED APPLICATIONS

This application claims priority from German Patent Application No. 10 2010 025 585.8, filed Jun. 29, 2010, which application is incorporated herein by reference in its entirety.

### FIELD OF THE INVENTION

The invention relates to a vibration damping device.

### BACKGROUND OF THE INVENTION

A vibration damping device of this sort situated in a drive train of a motor vehicle is known from DE 10 2006 028 556 A1. The vibration damping device makes it possible to transmit torque coming from an input drive side, for example, from an internal combustion engine, to an output side, for example, a transmission; and is also able to effect a damping of torsional vibrations, such as may be caused by the internal combustion engine. To that end, the vibration damping device has a drive part, and an output part that is rotatable to a limited extent relative to the input part through the action of at least one energy storage element.

Furthermore, the vibration damping device has a centrifugal force oscillating device to further dampen the torsional vibrations in the drive train, which has a pendulum mass carrier that is rotatable around an axis of rotation, and at least one pair of pendulum masses situated thereon, comprising two axially opposing pendulum masses, which are connected to each other with the aid of attaching elements that reach through cutouts in the pendulum mass carrier. The pair of pendulum masses are pivotable to a limited extent relative to the pendulum mass carrier via two roll-off elements, where the roll-off elements are each guided and rollable in runways in the pendulum mass carrier and in respective runways in the pendulum masses of the pair of pendulum masses, and where in each case one roll-off element, by rolling, passes over a roll-off surface on the pendulum mass carrier and on each of the pendulum masses as the pendulum masses move relative to the pendulum mass carrier.

### BRIEF SUMMARY OF THE INVENTION

Accordingly, a vibration damping device in a drive train of a motor vehicle is proposed, having a drive part and an output part that is rotatable to a limited extent relative to the drive part through the action of at least one energy storage element, and possibly at least one intermediate part that is incorporated between the input part and output part, producing a rotational effect through the action of another energy storage element, there being a pendulum mass carrier situated or formed on the drive part and/or the intermediate part and/or the output part, which makes it possible to receive at least one pair of pendulum masses comprising pendulum masses that are situated opposite each other axially on the pendulum mass carrier and are pivotable to a limited extent relative to the latter with the aid of at least one roll-off element, and where the roll-off element, by rolling, passes over a roll-off surface on the pendulum mass carrier and on each of the pendulum masses as the pendulum masses move relative to the pendulum mass carrier, and where the pendulum masses of a pair of pendulum masses have different geometric forms. This improves the construction space requirement of the vibration damping device; in particular, it is possible to achieve an appropriate adaptation of the centrifugal force oscillating device, and thereby of the vibration damping device, to corresponding construction space requirements. For example, the centrifugal force oscillating device may be adapted to an available space which differs on the two sides of the pendulum mass carrier, while at the same time making it possible to achieve the best possible damping properties of the vibration damping device.

The object of the invention is to improve the construction space requirement of a vibration damping device.

In a preferred embodiment of the invention, the geometric difference consists in the radial and/or axial extension of the pendulum masses.

In another embodiment of the invention, one pendulum mass of the pair of pendulum masses has a first radial and a first axial extension and the second pendulum mass has a second radial extension and a second axial extension, the second radial extension being smaller than the first and the second axial extension being greater than the first.

In a preferred embodiment of the invention, the axial line of the center of mass of the pair of pendulum masses lies within the axial extension of the pendulum mass carrier. Advantageously, the axial line of the center of mass of the pair of pendulum masses is axially centered in relation to the roll-off surface of the pendulum mass carrier, making it possible to achieve a uniform loading and rolling motion of the roll-off element.

In another preferred embodiment of the invention, the axial extension of the roll-off surface of one pendulum mass is unequal or equal to the axial extension of the roll-off surface of the other pendulum mass of the pair of pendulum masses. Depending on the axial extension of the pendulum masses and the axial extension of the roll-off element in the pendulum masses, different or equal axial extensions of the roll-off surfaces may be achieved in each case in the pendulum masses.

In another design of the invention, the axial extension of the roll-off surface of the pendulum mass carrier is smaller than the axial extension of the pendulum mass carrier. Advantageously, the pendulum mass carrier has at least one axial embossing in the area of the roll-off element.

In a preferred design of the invention, the axial extension of the roll-off surface of one pendulum mass is smaller than the axial extension of the pendulum mass.

In another preferred design of the invention, the roll-off element has a constant diameter over its axial extension, or at least two different diameters. Advantageously, the roll-off element is designed as a step pin.

Additional advantages and advantageous designs of the invention are derived from the description and the illustrations, in which accurately scaled representation has been dispensed with in the interest of clarity. All explained features are applicable not only in the indicated combination, but also in other combinations or by themselves, without departing from the confines of the invention.

### BRIEF DESCRIPTION OF THE DRAWINGS

The invention will be described in detail below with reference to the illustrations. The figures show the following details:

FIG. 1 illustrates a half-section through a vibration damping device designed as a torsional vibration damper, having a centrifugal force oscillating device according to state-of-the-art technology;

FIG. 2 is a detail of a cross-section through a centrifugal force oscillating device in a special embodiment of the invention;

FIG. 3 is a detail of a cross-section through a centrifugal force oscillating device in another special embodiment of the invention;

FIG. 4 is a detail of a cross-section through a centrifugal force oscillating device in another special embodiment of the invention; and,

FIG. 5 is a detail of a cross section through a centrifugal force oscillating device in another special embodiment of the invention.

### DETAILED DESCRIPTION OF THE INVENTION

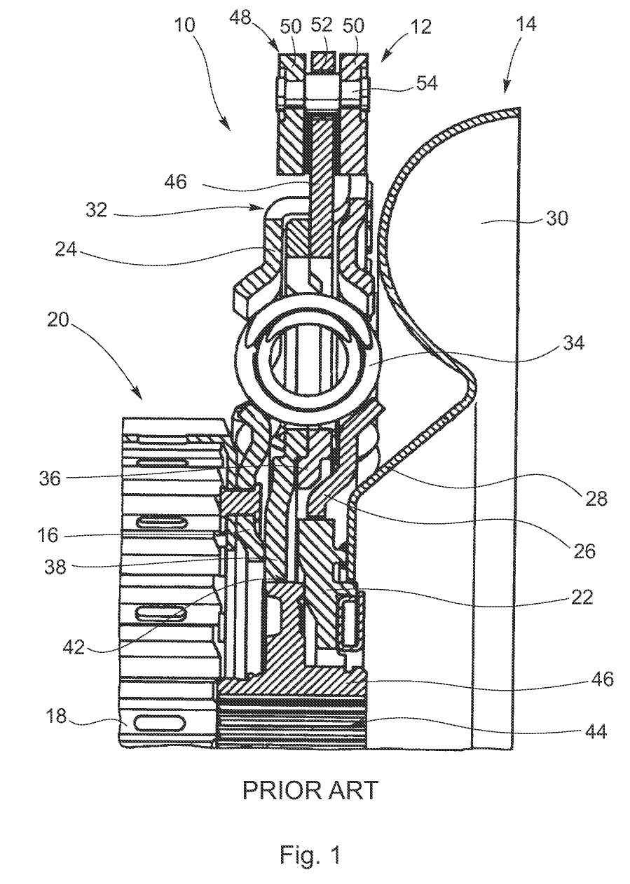

FIG. 1 depicts a half section through a vibration damping device 10 designed as a torsional vibration damper, having a centrifugal force oscillating device 12 according to start-of-the-art technology. Vibration damping device 10 is situated within a housing, not shown here, of a hydrodynamic torque converter 14, drive part 16 of vibration damping device 10 being connected in a rotationally fixed connection to a plate carrier 18 of a torque converter lockup clutch 20 and a turbine hub 22. To that end, drive part 16 is divided into two disk parts 24, 26, one disk part 24 being connected to plate carrier 18 and the other disk part 26 being connected to turbine hub 22, which in turn is attached to a turbine wheel shell 28 of a turbine wheel 30 of the hydrodynamic torque converter 14. The two disk parts 24, 26 are spaced apart from each other, except for a radially outer sub-segment 32 within which two disk parts 24, 26 are brought together axially and joined together in a rotationally fixed connection.

Drive part 16 is rotatable to a limited extent relative to a disk-like intermediate part 36 that is received axially between the two disk parts, through the action of a plurality of circumferentially adjacent first energy storage elements 34. To that end, first energy storage elements 34, in the form of helical springs, are received and subject to loading in corresponding receptacles in drive part 16 and intermediate part 36. Inserted axially next to intermediate part 36, but still axially within the two disk parts 24, 26, is an output part 38, which is rotatable to a limited extent relative to intermediate part 36 through the action of two energy storage elements which are not shown here. Output part 38 is attached to a power output hub 40 by means of a welded connection 42, power output hub 40 having inner toothing 44 to connect it to a transmission input shaft.

Integrally formed on a radial extension of intermediate part 36 is a pendulum mass carrier 46, which to that end reaches through cutouts in the two disk parts 24, 26 of the drive part in such a way that a relative rotational motion may be enabled. Pendulum mass carrier 46 makes it possible to receive a pair of pendulum masses 48, comprising two pendulum masses 50 positioned axially opposite each other on pendulum mass carrier 46. As shown in this sectional view, the pendulum masses 50 are connected to each other with the aid of attaching elements 54 that reach through cutouts 52 in the pendulum mass carrier. The cutouts 52 are shaped in this case so that a motion path of the pendulum masses 50 relative to pendulum mass carrier 46 is possible. For example, the cutouts 52 have a kidney-shaped form.

The actual motion path of the pendulum masses 50 relative to pendulum mass carrier 46 is made possible by roll-off elements that are not shown in this sectional view, which are guided and able to roll off in runways formed by cutouts in pendulum mass carrier 46 and in runways in the pendulum masses 50 of the pair of pendulum masses, and in each case one roll-off element, by rolling, passes over a roll-off surface on the pendulum mass carrier 46 and on each of the pendulum masses 50 as the pendulum masses 50 move relative to the pendulum mass carrier 46. The runways of pendulum mass carrier 46 may have a kidney-shaped form, and are curved opposite to the runways formed on the pendulum masses 50.

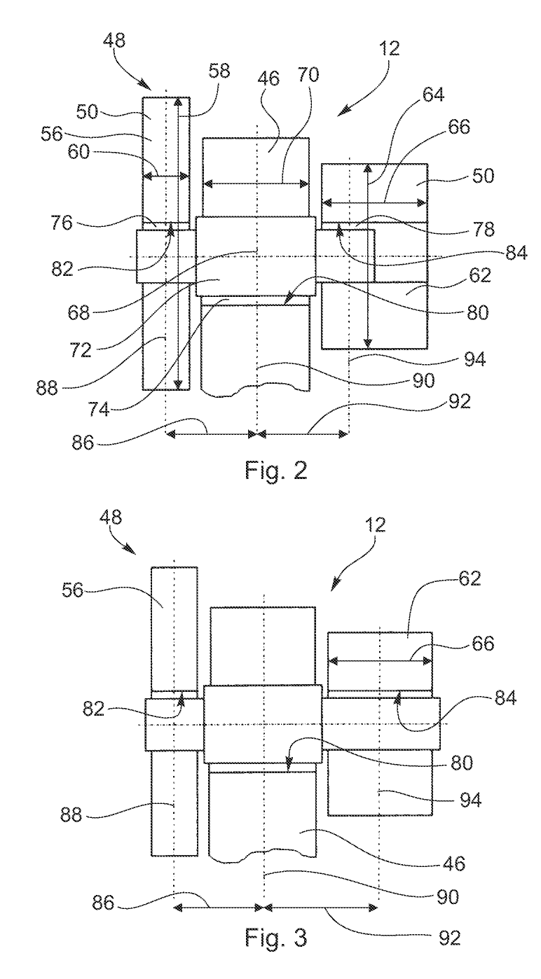

FIG. 2 shows a detail of a cross section through a centrifugal force oscillating device 12 in a special embodiment of the invention. The pendulum masses 50 of a pair of pendulum masses 48 differ in their geometric form. The first pendulum mass 56 of pendulum mass pair 48 has a first radial extension 58 and a first axial extension 60, and second pendulum mass 62 has a second radial extension 64 and a second axial extension 66, second radial extension 64 being smaller than first radial extension 58 and second axial extension 66 being greater than first axial extension 60. At the same time, the axial line of the center of mass 68 pendulum mass pair 48 lies within the axial extension 70 of pendulum mass carrier 46, in particular centered axially.

First and second pendulum masses 56, 62 are combined into a pair of pendulum masses 48 with the aid of an attaching element, not depicted here, which reaches through a cutout in pendulum mass carrier 46. The limited pivoting motion of first and second pendulum masses 56, 62 relative to pendulum mass carrier 46 takes place through a roll-off element 72, for which the latter is guided and rollable in a runway 74 formed by a cutout in pendulum mass carrier 46 and in runways 76, 78 formed by cutouts in first and second pendulum masses 56, 62. Roll-off element 72, designed in particular as a step pin, has two different diameters over its axial extension, the smaller diameter in each case being located axially to the outside in the area of first and second pendulum masses 56, 62.

When first and second pendulum masses 56, 62 move relative to pendulum mass carrier 46, roll-off element 72, by rolling, passes over a roll-off surface 80 on pendulum mass carrier 46 and a roll-off surface 82, 84 on each of the first and second pendulum masses 56, 62. The axial distance 86 of the axial center point 88 of roll-off surface 82 of first pendulum mass 56 from the axial center point 90 of roll-off surface 80 of pendulum mass carrier 46 and the analogous axial distance 92 of the axial center point 94 of roll-off surface 84 of second pendulum mass 62 is equal. In particular, the axial extension of roll-off surfaces 82, 84 on each of first and second pendulum masses 56, 62 is also equal. The axial extension of roll-off surface 84 of second pendulum mass 62 is smaller than the axial extension 66 of second pendulum mass 62, whereas the axial extension of roll-off surface 82 of first pendulum mass 56 is equal to the axial extension 60 of first pendulum mass 56.

FIG. 3 shows a detail of a cross-section through a centrifugal force oscillating device 12 in another special embodiment of the invention. In contrast to the design according to FIG. 2, the axial extension of roll-off surface 84 on second pendulum mass 62 of the pair of pendulum masses 48 is equal to the axial extension 66 of second pendulum mass 56. Here too, the axial distance 86 of the axial center point 88 of roll-off surface 82 of first pendulum mass 56 from the axial center point 90 of roll-off surface 80 of pendulum mass carrier 46 is smaller in comparison to the analogous axial distance 92 of second pendulum mass 62.

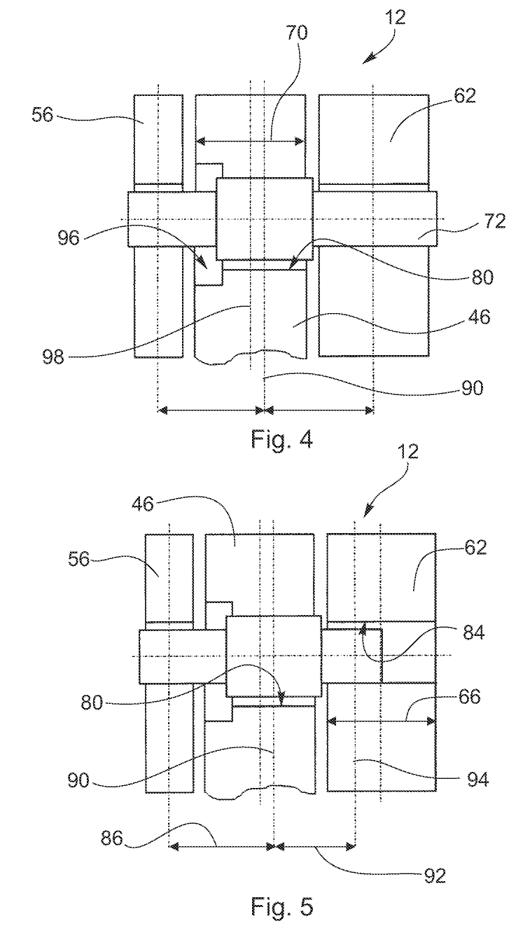

FIG. 4 shows a detail of a cross section through a centrifugal force oscillating device 12 in another special embodiment of the invention. In this example, in contrast to the embodiment in FIG. 3, an axial embossing 96 is made in pendulum mass carrier 46 in the area of roll-off element 72, whereby the axial extension of roll-off surface 80 on pendulum mass carrier 46 is reduced correspondingly, and the axial center point 90 of this roll-off surface 80 is also offset relative to the axial center 98 of pendulum mass carrier 46. In this case, the design and arrangement of the first and second pendulum masses 56, 62 are conducted such that the axial line of the center of mass 68 of first and second pendulum masses 56, 62 coincides with the axial center point 90 of roll-off surface 80 of pendulum mass carrier 46. Here too, the axial extension of roll-off surface 82 of pendulum mass carrier 46 is smaller than the axial extension 70 of pendulum mass carrier 46.

FIG. 5 shows a detail of a cross section through a centrifugal force oscillating device 12 in another special embodiment of the invention. In contrast to the embodiment according to FIG. 4, roll-off surface 84 of second pendulum mass 62 is axially shortened, analogous to the example in FIG. 2, meaning that the axial extension of roll-off surface 84 is smaller than the axial extension 66 of second pendulum mass 62, and the axial distance 92 of the center point 94 of roll-off surface 84 of second pendulum mass 62 from the axial center point 90 of roll-off surface 80 of pendulum mass carrier 46 is smaller than the analogous axial distance 86 of first pendulum mass 56.

### REFERENCE NUMBERS

10 vibration damping device

12 centrifugal force oscillating device

14 torque converter

16 drive part

18 plate carrier

20 torque converter lockup clutch

22 turbine hub

24 disk part

26 disk part

28 turbine wheel shell

30 turbine wheel

32 sub-segment

34 energy storage element

36 intermediate part

38 output part

40 output hub

42 welded connection

44 inner toothing

46 pendulum mass carrier

48 pendulum mass pair

50 pendulum masses

52 cutout

54 attaching element

56 pendulum mass

58 radial extension

60 axial extension

62 pendulum mass

64 radial extension

66 axial extension

68 center of mass

70 axial extension

72 roll-off element

74 runway

76 runway

78 runway

80 roll-off surface

82 roll-off surface

84 roll-off surface

86 axial distance

88 axial center point

90 axial center point

92 axial distance

94 axial center point

What we claim is:

1. A vibration damping device (10) in a drive train of a motor vehicle, having an input drive part (16) and an output part (38) that is rotatable to limited extent relative to the input part (16) through the action of at least one energy storage element (34), and possibly at least one intermediate part (36) that is incorporated between input part (16) and output part (38), producing a rotational effect through the action of another energy storage element, there being a pendulum mass carrier (46) situated or formed on the input part (16) and/or the intermediate part (36) and/or the output part (38), which makes it possible to receive at least one pair of pendulum masses (48) comprising pendulum masses (50) that are situated opposite each other axially on the pendulum mass carrier (46) and are pivotable to a limited extent relative to the latter with the aid of at least one roll-off element (72), and where the roll-off element (72), by rolling, passes over a roll-off surface (80, 82, 84) on the pendulum mass carrier (46) and on each of the pendulum masses (50) as the pendulum masses move relative to the pendulum mass carrier (46), characterized in that the pendulum masses (50) of a pair of pendulum masses (48) have different geometric forms.

2. The vibration damping device (10) according to claim 1, wherein the geometric difference is in the radial (58, 64) and/or axial extension (60, 66) of the pendulum masses (50).

3. The vibration damping device (10) according to claim 1, wherein a first pendulum mass (56) of the pair of pendulum masses (48) has a first radial extension (58) and a first axial extension (60), and the second pendulum mass (62) has a second radial extension (64) and a second axial extension (66), the second radial extension (64) being smaller than the first radial extension (58) and the second axial extension (66) being greater than the first axial extension (60).

4. The vibration damping device (10) according to claim 1, wherein the axial line (68) of the center of mass of the pair of pendulum masses (48) lies within the axial extension of the pendulum mass carrier (46).

5. The vibration damping device (10) according to claim 4, wherein the axial line (68) of the center of mass of the pair of pendulum masses (48) is axially centered in reference to the roll off surface (80) of the pendulum mass carrier (46).

6. The vibration damping device (10) according to claim 1, wherein the axial extension of the roll-off surface (82, 84) of one pendulum mass (50) is unequal or equal to the axial extension of the roll-off surface (84, 82) of the other pendulum mass (50) of the pair of pendulum masses (48).

7. The vibration damping device (10) according to claim 1, wherein the axial extension of the roll-off surface (80) of the pendulum mass carrier (46) is smaller than the axial extension (70) of the pendulum mass carrier (46).

8. The vibration damping device (10) according to claim 1, wherein the pendulum mass carrier (46) has at least one axial embossing (96) in the area of the roll-off element (72).

9. The vibration damping device (10) according to claim 1, wherein the axial extension of the roll-off surface (82, 84) of one pendulum mass (50) is smaller than the axial extension (60, 66) of the other pendulum mass (50).

10. The vibration damping device (10) according to claim 1, wherein the roll-off element (72) has a constant diameter or at least two different diameters over its axial extension.
